(19) United States
(12) Patent Application Publication
(10) Pub. No.: US 2002/0115456 A1
(43) Pub. Date: Aug. 22, 2002

(54) Method and system for coding ring tones for cellular telephones

(76) Inventors: Tero Narinen, Espoo (FI); Matti Suomalainen, Helsinki (FI); Timothy Lee Dennis, Olney, MD (US)

Correspondence Address: BROWN, RAYSMAN, MILLSTEIN, FELDER & STEINER LLP, 900 THIRD AVENUE, NEW YORK, NY, 10022, US

(21) Appl. No.: 09/733,687

(22) Filed: Dec. 8, 2000

(51) Int. Cl. H04Q 7/20

(52) U.S. Cl. 455/466; 455/567

(57) ABSTRACT

A method and system for efficiently coding ring tone data and other data for delivery to telephone handsets, such as in a mobile telephone network. In one aspect, the data are encoded using a compact, byte-aligned format that is easy to parse. The data are provided in code words having respective code portions (bit positions) that are correlated by their relative positions within the code word with a respective characteristic of the data, such as a ring tone (e.g., note, length, octave, and volume). Accordingly, there is no need to provide identifiers for each characteristic. In another aspect, special instructions (e.g., tempo changes and looping) for modifying ring tone data or other data are chained to a code word that contains the baseline (nominal) characteristics to maintain compatibility with telephones that do not recognize special instructions.

### BACKGROUND OF THE INVENTION

The present invention relates to a method and system for coding ring tone data and other types of data, such as for use with telephones in mobile communication networks.

The popularity of cellular and other mobile telephone networks has resulted in the desire to provide customized features to enable users to personalize their telephones. One way this may be accomplished is by providing distinctive ring tones (also known as ringing tones and mobile melodies) for different telephone handsets. This allows the telephone to be personalized with pleasing ring tones. Moreover, the provisioning of different ring tones allows users to recognize whether their phone is ringing in a crowd of other users. Some ring tones may provide distinctive sound effects, while others provide popular melodies. Moreover, the idea of providing a ring tone that identifies the caller has been explored.

Typically, each telephone is programmed at the time of manufacture with a limited number of ring tones that the user may select among, e.g., via a menu and keypad on the telephone. This approach is economical and provides the user with a baseline selection of ring tones. However, the user may desire to configure his telephone with new ring tones that are developed. Some existing approaches enable the user to program a ring tone into the telephone, e.g., by operating the keys on the keypad in a specified sequence. The user may even compose ring tones with this approach. However, this requires additional keystrokes to identify specific letters and is therefore an error-prone process. Another approach enables the user to download ring tone data from an Internet web site for storage in the telephone. However, this requires access to a computer, and significant effort on the user's part, and does not address how the data is delivered to the telephone.

A further approach, described in U.S. Pat. No. 6,094,587, is to encode the data as characters, such as ASCII characters, and transmit the characters over a network signaling channel using the Short Message Service (SMS). However, this approach is not efficient since a full character is used for each piece of information, e.g., each note, tempo modifier, and so forth.

SMS allows the transmission of messages having up to 160 characters. SMS has been used over GSM networks, which are used throughout Europe. Most digital phones use one of three main technologies, i.e., Global System for Mobile communications (GSM), Code-Division Multiple Access (CDMA) and Time-Division Multiple Access (TDMA).

A further approach, described in the Smart Messaging Specification, Revision 2.0.0, 1999-05-17, Nokia Mobile Phones Ltd, is an open platform for providing various messaging capabilities, including business cards, Internet access, graphical logos and ring tones. For ring tone encoding, various instruction identifiers and corresponding instructions (e.g., for note, scale, style, tempo, and volume) are provided in a coding syntax. However, this approach incurs significant overhead, thereby unnecessarily consuming channel bandwidth and processing cycles at the upstream transmitter and the telephone. Moreover, the use of variable length code words results in a more complex implementation.

Accordingly, there is a need for a method and system for efficiently coding ring tone data and other data, e.g., for communication to a telephone.

The present invention provides such a method and system.

### SUMMARY OF THE INVENTION

It is an object of the present invention to solve the problems described above associated with existing approaches for encoding ring tone data and other data.

It is an object of the invention to provide a method and system for encoding ring tone and other data in a compact format that is suitable for configuring wireless handsets using over-the-air mechanisms.

It is an object of the invention to provide a coding format that is compact and efficient.

It is an object of the invention to provide a method and system for encoding and transmitting data from a network transmitter to one or more telephones, or from one phone to one or more other telephones.

It is an object of the invention to provide a data encoding method and system that enables storage of the data at telephones, or immediate playback without storage.

The invention provides for coding of ring tone and other data in one or more code words, each having a plurality of code portions. Each code portion has a predetermined length. Moreover, the code words may have a fixed length. The portions of code words and/or code portions are encoded and form part of an encoded ring tone or other data.

In the preferred embodiments, each word comprises one or more bytes. Byte positions, and bit positions within a byte, are encoded to provide or form part of the encoded data.

Special playback instructions can be chained to baseline data in a manner such that telephones that do not support the special instructions can bypass them while still recovering the baseline data. For a ring tone, the special instructions modify the baseline (nominal) ring tone characteristics.

The data may be encoded using a compact, byte-aligned, fixed-length code word format. Byte-aligned refers to a code word that has a length that is an integral number of bytes.

The method and system can be compatible with existing and future wireless telephone networks, including GSM, CDMA and TDMA.

In one aspect of the invention, encoded data is provided in at least a first code word having a plurality of respective code portions. In particular, each respective code portion comprises at least one bit and is correlated by its relative position within the code word with a respective characteristic of the data. By correlating the relative positions of the code portions with the ring tone or other data characteristics, there is no need to provide identifiers for each characteristic. This streamlines the implementation.

In another aspect of the invention, encoded data is provided with baseline data in at least a first code word having a plurality of respective code portions. At least one of the respective code portions of the first code word designates that at least a second code word follows the first code word and contains instruction data for modifying the baseline data. For example, for ring tone data, the instructions modify a playback at the telephone of the ring tone. In this manner, code words for special instructions can be chained to baseline data that provides the baseline telephone characteristics.

Corresponding encoding and decoding apparatuses and methods are presented.

### BRIEF DESCRIPTION OF THE DRAWINGS

The invention is illustrated in the figures of the accompanying drawings, which are meant to be exemplary, and not limiting, in which like references are intended to refer to like or corresponding structures, and in which:

FIG. 1 is a block diagram of a data reception process in accordance with the present invention;

FIG. 2 illustrates a ring tone data delivery system in accordance with the present invention;

FIG. 3 illustrates a ring tone data header structure of the encoded ring tone data; and

FIG. 4 illustrates a ring tone note encoding format of the encoded ring tone data.

### DETAILED DESCRIPTION OF THE PREFERRED EMBODIMENTS

Embodiments of the present invention will now be described in detail with reference to the accompanying figures.

Generally, the invention is compatible with a lightweight, efficient framework for customizing and configuring wireless handsets using over-the-air (OTA) mechanisms. They key requirements in the design of the framework are light weight (e.g., ease of implementation, fast time to market, in both the terminal and network sides, and low bandwidth requirements), openness (use existing standards when possible), and future compatibility (the usability of the framework must be ensured as terminals and networks gain new functionality).

“Telephone” is used herein to refer to a telephone handset or similar telephone receiver/device, which is not necessarily handheld. For example, telephone devices may be installed or placed in vehicles or other fixed or mobile objects (e.g., such as briefcases, clothing, headsets, and so forth).

The invention defines a mechanism for transporting data such as personalized ring tones or other data, and may use SMS messages as transport, in one possible implementation.

A generic scheme is defined that is used to communicate ring tone data, as well as other data, such as operator and caller group icons, and Wireless Application Protocol (WAP) Gateway access point configuration data. The data may be transferred using the same basic functionality regardless of content (ring tones, icons, etc.).

The coding scheme disclosed herein is compatible with WAP 1.2 specifications, including the Wireless Session Protocol (WSP), WAP Push Message, and WAP Push OTA. Although WAP protocols are often complex and time consuming to implement, the present invention only interacts with a small subset of these protocols, and therefore provides a small footprint on the terminal, as well as quick and easy implementation. The invention is also superior to traditional SMS-based mechanisms since it is not tied to SMS, but can be easily extended to support pull-based bearers with more bandwidth in the future. Moreover, the invention makes possible a minimal implementation in low-end terminals without any WAP functionality.

When defining a transmission framework that is usable over narrowband bearers such as GSM, SMS or TDMA R-Data, issues that need to be addressed include compact Protocol Data Unit (PDU) encoding.

The invention is compatible with the use of the Wireless Datagram Protocol (WDP) port addressing to target all content types to the terminal through a single WDP port using Connection WSP Push. The use of WDP ensures isolation from underlying network technology, and thus makes the framework usable in any wireless network technology (e.g., including GSM, TDMA, and CDMA).

For example, in the case of GSM-SMS, WDP is synonymous with SMS concatenation and port addressing that are defined in the European Telecommunication Standard (ETS) specification (document ETS 300 901, January 1998, 3^{rd} edition), and there is minimal implementation effort needed to enable a GSM phone to support WDP.

A special dispatcher application in the terminals listens to this WDP port and, after it receives the data, such as ring tone data, a specific application is targeted in the terminal by examining two WSP headers in the received WAP Push packet. These headers are “Content-type” and “X-Wap-Application-Id”. Wireless Session Protocol (WSP) header encoding is applied to these headers to minimize OTA message size. Again, only a small portion of the WSP specification is used, thereby minimizing the implementation complexity and time. Forward compatibility is also provided, since the small portion of the WSP specification that is used is a core portion that is expected to remain substantially unchanged in the future.

Moreover, as bearer networks become more sophisticated, connection-oriented WAP Push could be used for content delivery.

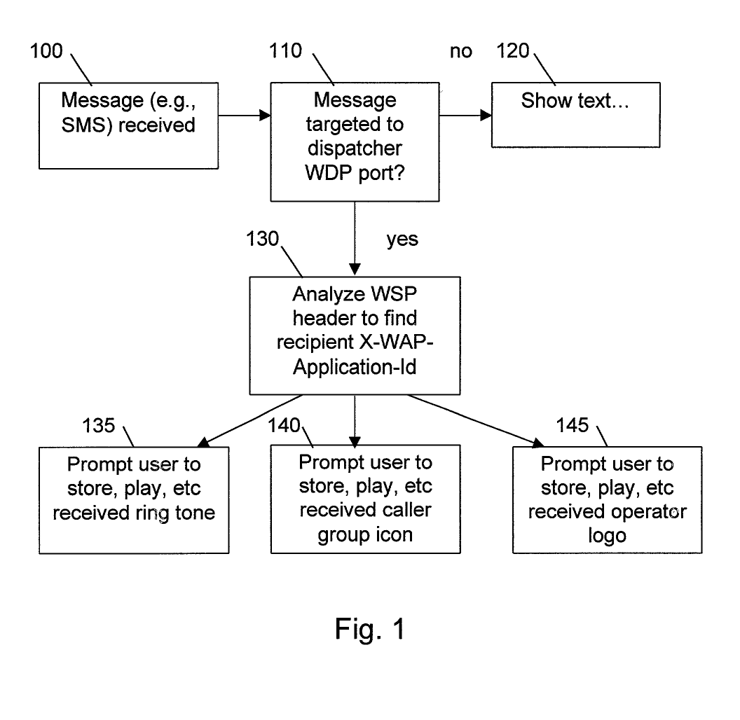

FIG. 1 is a block diagram of a data reception process in accordance with the present invention.

The phases of processing inside the terminal to route the ring tone data to the right application are shown. WDP segmentation and re-assembly (SAR) is omitted.

At block 100, a message is received at the telephone. At block 110, it is determined whether the message is targeted to a dispatcher WDP port. If not, the message contains conventional text, which is displayed (block 120). If the message is targeted to the dispatcher port, the WSP header is analyzed to determine an identifier of a recipient application, such as a ring tone application, a caller group icon application, or an operator logo application.

At block 135, 140, or 145, for ring tone data, caller group icon data, or operator logo data, respectively, the user is prompted to take some action regarding the received data, such as storing it, playing it, etc.

The last byte (last eight bits) of the data contains a checksum, regardless of the data content, that is used to check that the data content has remained unchanged during transmission. When calculating the checksum, all bytes after the WSP header, excluding the checksum byte itself, are used. Any suitable checksum technique may be used.

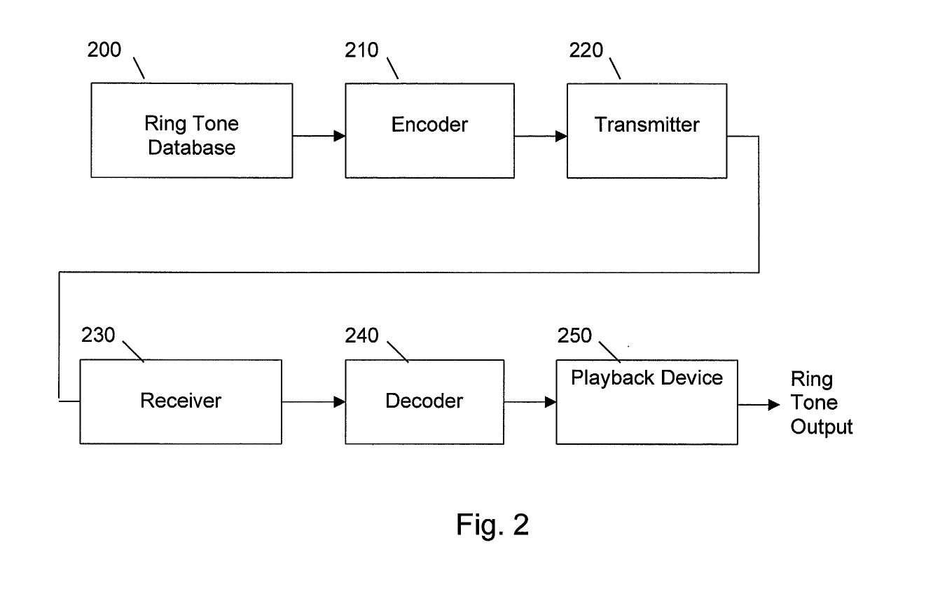

FIG. 2 illustrates a ring tone delivery system in accordance with the present invention.

A ring tone database 200 stores a variety of available types of ring tones. The encoder 210 encodes the ring tones obtained from the database 200 into encoded ring tone data for transmission via a transmitter 220 to one or more telephones. A telephone includes a receiver 230 for receiving the encoded ring tone data, a decoder 240 for decoding the encoded ring tone data, and a playback device 250 for playing back the delivered ring tone, e.g., through a speaker.

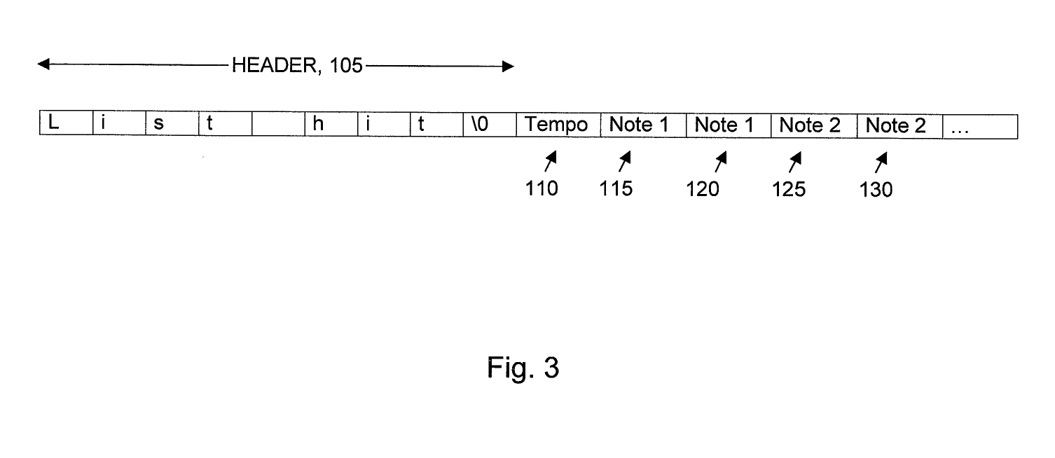

FIG. 3 illustrates a ring tone header structure of the encoded ring tone data. The following syntax identifies the data or message content, in this case ring tones (audio), and the application used to decode the information: MIME-type:audio/vnd.zrt; and X-Wap-Application-Id:zrt, where MIME denotes the Multipurpose Internet Mail Extensions.

The encoded ring tone data is composed of two parts. A header 105 contains the title of the ring tone, e.g., as a UTF-8 null-terminated string. The UTF-8 encoding system is defined in ISO 10646-1 Annex R and RFC 2279. UTF refers to a Universal character set Transformation Format. The header is followed by an eight-bit value 110 which specifies the tempo, e.g., how fast the song or melody of the ring tone should be played. The header does not contain the length of the tone, or number of notes in it. This information is always available from the transport layer.

Notes are encoded using a compact and easy-to-parse format. In a preferred embodiment, each note is encoded using sixteen bits (two bytes). For example, a first note uses bytes 115 and 120, while a second note uses bytes 125 and 130, and so forth. Thus, up to sixty-four notes can be carried in a single GSM-SMS WDP chunk (e.g., segment). The first chunk may carry one bit less due to WSP header overhead. Moreover, preferably, the encoded ring tone data is composed using constant width note instructions, which results in efficient encoding and decoding.

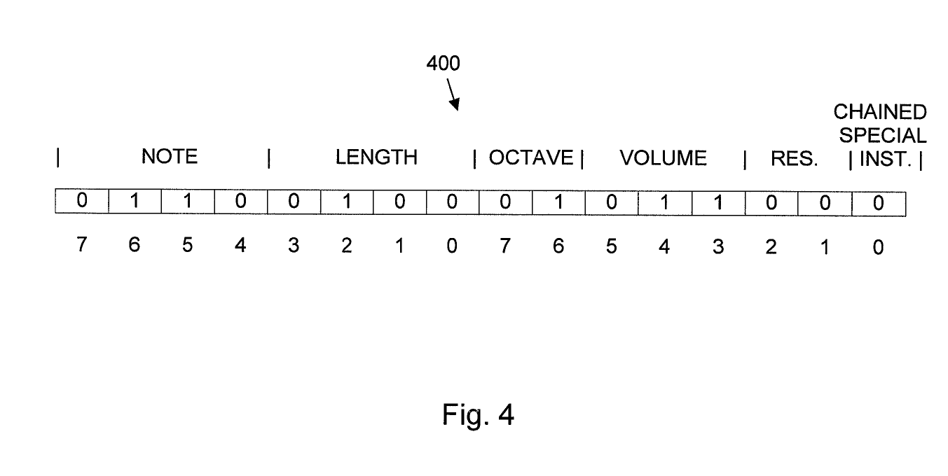

FIG. 4 illustrates a ring tone note encoding format of the encoded ring tone data.

The tables below illustrate how a single note is encoded. The values correspond to quarter note F^{#} in low octet, volume level 4.

In each code word 400, the upper four bits of the first byte specify the note. Piano keyboard note-to-key mapping is used to decrease complexity. The lower four bits of the first byte specify the length of the note. Bits 6 and 7 of the second byte specify the octave, while bits 3, 4 and 5 specify the volume level. Bits 1 and 2 are reserved and should be set to zero.

Moreover, bit zero, if set to one, specifies that the following 16-bit block is a special instruction, e.g., for implementing sound looping, tempo changes in the middle of the ring tone, and so forth. Moreover, the special instructions can be chained to one another by setting bit 0 to 1 for the second byte of each special instruction block. That is, special instructions may be communicated via a contiguous string of one or more 16-bit blocks by using a “1” in the zero bit. When the zero bit value returns to “0”, this designates that the content of the next block is no longer a special instruction.

The encoding system of the present invention advantageously allows terminals that do not implement the special instructions to be able to bypass any number of chained blocks of special instructions, e.g., which follow a note with the special instruction indicator bit set. Telephones that do not implement the variety of features provided by the encoding system of the present invention should implement a best-efforts functionality. Thus, if an unsupported level of functionality is encountered for the ring tone data, the telephone converts the instruction (note, length, volume, etc.) to the closest possible representation.

Tables 1 through 4 specify example values for different ring tone fields. These values are used in byte locations 115-130 of FIG. 3. A ring tone characteristic is mapped to a code portion in each table. Note that the number of bits allocated to the code portion for each characteristic is an example only. “#” denotes a sharp note, and “b” denotes a flat note.

| Table 1 | | Table 2 | | Table 3 | | Table 4 | |
|---|---|---|---|---|---|---|---|
| Note | Code | Length | Code | Octave | Code | Volume | Code |
| C | 0000 | Whole | 0000 | very low | 00 | level-1 | 000 |
| C^{#} (D^{b}) | 0001 | 3/2 | 0001 | Low | 01 | level-2 | 001 |
| D | 0010 | ½ | 0010 | mid | 10 | level-3 | 010 |
| D^{#} (E^{b}) | 0011 | ¾ | 0011 | High | 11 | level-4 | 011 |
| E | 0100 | ¼ | 0100 | | | level-5 | 100 |
| F | 0101 | ⅜ | 0101 | | | level-6 | 101 |
| F^{#} (G^{b}) | 0110 | ⅛ | 0110 | | | level-7 | 110 |
| G | 0111 | 3/16 | 0111 | | | level-8 | 111 |
| G^{#} | 1000 | 1/16 | 1000 | | | | |
| A | 1001 | 3/32 | 1001 | | | | |
| A^{#} (B^{b}) | 1010 | 1/32 | 1010 | | | | |
| B | 1011 | 3/64 | 1011 | | | | |
| Reserved | 1100 | Reserved | 1100 | | | | |
| Reserved | 1101 | Reserved | 1101 | | | | |
| Reserved | 1110 | Reserved | 1110 | | | | |
| rest/pause | 1111 | Reserved | 1111 | | | | |

In addition to ring tone data, different kinds of icons may be encoded for transmission using defined size bitmaps. Wireless Bitmap (WBMP) type 0, which is a compact and easy to implement encoding for small monochrome bitmaps, may be used. A maximum size of any icon may be limited to a width of sixty-four pixels and a height of twenty pixels. The WBMP format itself does not limit the size, the above-mentioned size limitation ensures very efficient coding, as WBMP encoding is most efficient for images where width is divisible by eight pixels (with no remainder). With this maximum size, even the biggest icon can be easily transferred using only two SMS messages.

The “Content-type” in WSP headers for all icons shall be image/vnd.wap.wbmp. Specific application (operator logo, caller group, picture messaging) in the terminal is targeted using “X-Wap-Application-Id.” This ensures an easy growth path if the terminal/telephone supports multiple data types for the same purpose. “X-Wap-Application-Id” remains the same, and “Content-type” is changed according to the encoding.

An example of icon encoding is as follows. Binary coding of simple type 0 WBMP bitmap is provided. Image data is encoded as twenty rows of sixty-four bits, where a set bit (1) represents black, and a non-set bit (0) represents 0. Here, each row takes eight bytes. If the row length is not dividable by eight, a new row shall be started from a byte boundary. Any bits left over shall be set to zero. A transmission checksum is not present in this example.

| Byte | Value | Comment |
|---|---|---|
| 1 | 0x00 | WBMP Type 0 |
| 2 | 0x00 | No extension headers |
| 3 | 0x40 | 0x40 = 64 decimal, bitmap width |
| 4 | 0x14 | 0x14 = 20 decimal, bitmap height |
| 5 . . . 164 | | Image data |

For operator logos (ol), only a specific “X-Wap-Application-Id” needs to be defined to target the uploaded icons to a correct application, e.g., to be constantly displayed on the screen when the phone is turned on and no call is in progress: X-Wap-Application-Id:ol. If it is desired to combine the downloaded icon with a specific operator, the WBMP extension header can be easily used to accomplish this.

For caller group icons (ci): X-Wap-Application-Id:ci.

1. WAP Access Point Settings

For WAP Access point settings (Dial-in number, dial-in username, dial-in password . . . ) the information is encoded using a limited subset of “WAP Provisioning Content” specification that is simple and compact and fulfills the requirements of provisioning WAP 1.1 handsets. This content is binary-encoded according to encoding rules defined in “Binary XML Content Format Specification” (WBXML) and in “WAP Provisioning Content”:

MIME-Type: application/vnd.wap.connectivity-wbxm1.

Of the total WAP Provisioning architecture, only a subset of WAP Provisioning Content is used. The WAP Provisioning architecture is very wide in scope and place great demands on the infrastructure (e.g., WAP Gateway, WAP Push Gateway, SIM-cards, www-servers) and thus takes much more effort and time to implement. However, if only content type is used, the functionality can be implemented in a very reasonable time without many interdependencies between components.

1.1 XML DTD (Extensible Markup Language Document Type Definition)

The same XML DTD is used as for WAP Provisioning Content. This DTD is very simple and does not enforce a very strict structure to the content. Most of the structure for WAP Provisioning Content is defined outside the DTD and this makes it possible to simplify the structure a great deal. XML DTD for the content is shown below.

<!ELEMENT wap-provisioningdoc (characteristic+)>
<!ATTLIST wap-provisioningdoc
secmethod CDATA #IMPLIED
mac CDATA #IMPLIED
version CDATA #IMPLIED
>
<!ELEMENT characteristic (parm*, characteristic*)>
<!ATTLIST characteristic
type CDATA #REQUIRED
>
<!ELEMENT parm EMPTY>
<!ATTLIST parm
name CDATA #REQUIRED
value CDATA #IMPLIED
>

The following defines the selected subset of WAP Provisioning content. The following characteristics are used in this specification: PXLOGICAL, PXPHYSICAL, PORT, and NAPDEF. An example Provisioning document follows:

<?xml version=“1.0”?>
<!doctype wap-provisioningdoc public “-//WAPFORUM//DTD PROV 1.0//EN”
“http://www.wapforum.org/DTD/wapprov.dtd”>
<wap-provisioningdoc>
<characteristic type=“PXLOGICAL”>

<parm name=“NAME” value=“exampleProxy”/>
<parm name=“STARTPAGE” value=“http://wap.ztango.com”/>
<characteristic type=“PXPHYSICAL”>

<parm name=“PXADDR” value=“192.168.1.1”/>
<characteristic type=“PORT”>

<parm name=“PORTNBR” value=“9203”/>

</characteristic>
<parm name=“TO-NAPID” value=“NAP1”/>

</characteristic>

</characteristic>
<characteristic type=“NAPDEF”>

<parm name=“NAPID” value=“NAP1”/>
<parm name=“BEARER” value=“GSM-CSD”/>
<parm name=“NAP-ADDRESS” value=“+358301101032”/>
<parm name=“NAP-ADDRTYPE” value=“E164”/>
<parm name=“AUTHTYPE” value=“PAP”/>
<parm name=“AUTHNAME” value=“user”/>
<parm name=“AUTHSECRET” value=“secret1”/>
<parm name=“CALLTYPE” value=“V.110”/>

</characteristic>
</wap-provisioningdoc>

PAP denotes the packet authentication protocol. CSD denotes circuit switched data.

1.3 CHARACTERISTIC Elements

1.3.1 PXLOGICAL

PXLOGICAL characteristic presents one logical proxy, e.g., one configuration context and may only occur in the root of the provisioning document. It must include PXPHYSICAL characteristic and may include PORT characteristics.

1.3.2 PXPHYSICAL

PXPHYSICAL represents one physical proxy. PXPHYSICAL characteristic can include PORT characteristics and must refer to at least one NAPDEF.

1.3.3 PORT

PORT characteristic defines which port of the physical proxy the terminal will connect to. In one possibility, only port number bindings defined in WDP are used, e.g., Port number 9201 cannot represent a service other than a WSP connection-oriented unsecure service. May only occur in PXLOGICAL and PXPHYSICAL characteristics.

1.3.4 NAPDEF

NAPDEF characteristics defines/represents one Network Access Point, for example, dial-in modem pool, Short Message Service Center (SMSC), etc.

1.4 PARM Elements

The PARM element is general purpose slot for all parameters under different characteristics. Parameters which do not add value can be omitted. For example, if no proxy authentication is performed, PXAUTH-TYPE, PXAUTH-ID and PXAUTH-PW can be omitted. Similarly, parameters not differing from the default values can be omitted. For example, if PORTNBR equals 9201, it can be omitted. The description of each parameter specifies whether the parameter is required or optional

1.4.1 Parameters for PXLOGICAL

In the scope of this specification, PROXY-ID is not required. This deviates from WAP Provisioning Content-type.

NAME

NAME indicates user-indentifiable name of this configuration context, for example, “My Carrier.” It is required (1 entry).

PXAUTH-TYPE

Indicates proxy authentication method. Possible values are: NONE and HTTP. Optionally, if it is missing, no proxy authentication is used. (0-1 entries).

PXAUTH-ID

Proxy authentication identifier. Optionally, if it is missing, no proxy authentication is used. (0-1 entries).

PXAUTH-PW

Proxy authentication password. Optionally, if it is missing, no proxy authentication is used. (0-1 entries).

STARTPAGE

The homepage for this configuration context. It is required (1 entry). Requiring this deviates from WAP Provisioning content.

1.4.2 Parameters for PXPHYSICAL

PXADDR

Defines address of this physical proxy. Type and format specified by PXADDRTYPE. REQUIRED (1 entry).

PXADDRTYPE

Defines the type and format of PXADDR. Possible values are IPV4 (default) and E164, e.g., generic phone number.

TO-NAPID

Binds this physical proxy to use one (or two) of the network access points specified in the root of the provisioning document. It is required (1-2 entries).

1.4.3 Parameters for PORT

PORTNBR

Specifies the port to use. Must be given as a decimal number (16 bit unsigned integer). It is optional (0-1 entries). If omitted, a default is used. Possible values are as follows:

| Value | Comment |
|---|---|
| 9200 | Connectionless unsecure WSP |
| 9201 | Connection-oriented unsecure WSP (default) |
| 9202 | Connectionless secure WSP |
| 9203 | Connection-oriented secure WSP |

The NAPID is used to link the TO-NAPID in PXPHYSICAL to a Network Access Point. NAPID can have a value NAP1 or NAP2. These are the only ones that can be used in TO-NAPID. It is required (1 entry).

BEARER

Bearer indicates the network type for this NAPDEF. It is required (1 entry). Possible values are as follows:

GSM-SMS;
ANSI-136 GUTS;
IS-95-CDMA-SMS;
IS-95-CDMA-CSD;
IS-95-CDMA-PACKET;
ANSI-136-CSD;
ANSI-136 GPRS;
GSM-CSD; and
GSM-GPRS.
GPRS denotes the General Packet Radio Service.

GPRS denotes the General Packet Radio Service.

NAP-ADDRESS

Contains the connection string needed to contact the remote Network Access Point. The format and content depend on the bearer type, and are defined by NAP-ADDRTYPE. It might contain, for example, the phone number of the access modem pool, or the address of the SMSC.

NAP-ADDRTYPE

Defines the type of the address in NAP-ADDRESS. Can be omitted if a default is used. (0-1 entries). Possible values are IPV 4 (default), E 164 and APN (GPRS Access Point Name).

CALLTYPE

Call type of the bearer connection. Possible values are ANALOG_MODEM (default), V.120, V.110, X.31 and BIT_TRANSPARENT. Can be omitted if meaningless or if a default is used. (0-1 entries).

AUTHTYPE

Specifies what kind of authentication NAP requires. Possible values are NONE, PAP, CHAP (challenge handshake authentication protocol). Can be omitted if authentication is not needed (0-1 entries).

AUTHNAME

Contains plain text user identifier for authenticating the user to NAP. It is optional (0-1 entries).

AUTHSECRET

Contains plain text password needed to authenticate the user to NAP.

The following provides an example GSM-SMS WDP implementation. The User Data Header Indicator bit (bit 6 in PDU-type octet) must be set to 1 to tell the terminal that User Data contains a User Data Header. DCS value should be set to 0×F5, which indicates eight-bit data.

Illustrated below is a datagram header structure of the WDP implementation of GSM SMS, ANSI-136 GHOST (GSM hosted SMS teleservice)and PCS-1900 using ETSI-defined User Data Header framework that is supported by almost all current generation GSM and PCS-1900.

Bit

| | |
|---|---|
| | 0 1 2 3 4 5 6 7 |
| | Total length of User Data Header |
| | UDH LB identifier: 05 (16-bit port numbers) |
| | Port number LB length: 04 (bytes) |
| | Destination port (high) |
| Byte | Destination port (low) |
| | Originator port (high) |
| | Originator port (low) |
| | UDH LB identifier: 05 (SAR) |
| | SAR LB length: 03 (bytes) |
| | Datagram reference number |
| | Total number of SAR segments |
| | Sequence number of current segment |

The following illustrates a fill encoding example (GSM-SMS WDP, WSP, WBMP):

Segment 1:

| Byte | | |
|---|---|---|
| Value (hex) | Description | Notes |
| 0B | User Data Header Length | Total length of UDH: 11, |
| | | WDP info starts |
| 05 | UDH IE Identifier (16-bit | |
| | port numbers) | |
| 04 | IE Length | |
| 0B | Destination port (high) | 0x0BA7 = 2948 (standard |
| | | class push port) |
| A7 | Destination port (low) | |
| 75 | Originator port (high) | 0x7530 = 30000 |
| 30 | Originator port (low) | |
| 00 | UDH IE Identifier (SAR) | |
| 03 | IE Length | |
| F1 | Datagram reference number | |
| 02 | Total number of segments | |
| 01 | Number of current segment | WDP layer info ends here |
| E3 | Push identifier | WSP Layer start |
| 06 | WSP PDU type: PUSH | |
| 05 | WSP header length | |
| A1 | Content type: | |
| | image/vnd.wap.wbmp | |
| AF | X-Wap-Application-Id | |
| 63, 69, 0 | “ci” and terminating 0 | WSP info end |
| 00 | WBMP type 0 | WBMP header start |
| 00 | No extension headers | |
| 40 | WBMP image width = 64 | |
| 14 | WBMP image height = 20 | WBMP header end |
| FF . . . | WBMP data, first 120 bytes | |

Segment 2 demonstrates well how the header overhead burdens only the first segment, and includes a checksum:

| Byte | | |
|---|---|---|
| Value (hex) | Description | Notes |
| 0B | User Data Header Length | Total length of UDH: 11, |
| | | WDP info starts |
| 05 | UDH IE Identifier (16-bit port | |
| | numbers) | |
| 04 | IE Length | |
| 0B | Destination port (high) | 0x0BA7 = 2948 (standard |
| | | class push port) |
| A7 | Destination port (low) | |
| 75 | Originator port (high) | 0x7530 = 30000 |
| 30 | Originator port (low) | |
| 00 | UDH IE Identifier (SAR) | |
| 03 | IE Length | |
| F1 | Datagram reference number | |
| 02 | Total number of segments | |
| 02 | number of current segment | WDP layer info ends here |
| FF . . . | WBMP data, last 40 bytes | |
| 07 | Checksum byte value | |

Accordingly, it can be seen that the present invention provides a method and system for coding ring tone data or other data, e.g., for communication to an over-the-air telephone. The ring tone or other data are encoded using a compact, byte-aligned code word format that avoids the need for identifiers. Code word portions that correlate to characteristics of the data have a predetermined length, while the code word may have a fixed length. Moreover, special instructions for modifying the ring tone are chained to a code word that contains the baseline (nominal) ring tone characteristics to maintain compatibility with telephones that do not recognize special instructions.

While the invention has been described and illustrated in connection with preferred embodiments, many variations and modifications as will be evident to those skilled in this art may be made without departing from the spirit and scope of the invention. For example, in addition to delivering ring tones, the invention provides the ability to deliver icons, WAP access point settings, bitmaps, and the like. The invention is thus not to be limited to the precise details of methodology or construction set forth above as such variations and modification are intended to be included within the scope of the invention.

What is claimed is:

1. A method for encoding data for use by a telephone, comprising:
providing the data in at least a first code word having a plurality of respective code portions;
wherein each respective code portion comprises at least one bit and is correlated by its relative position within the first code word with a respective characteristic of the data.

2. The method of claim 1, wherein:
the respective code portions have respective predetermined lengths.

3. The method of claim 1, wherein:
the telephone is adapted to recover the respective characteristics of the data from the first code word according to the correlated position of each code portion therein.

4. The method of claim 3, wherein:
the telephone is adapted to play back the data in response to the recovered characteristics.

5. The method of claim 1, wherein:
the telephone comprises an over-the-air telephone.

6. The method of claim 1, wherein:
the first code word comprises an integral number of bytes.

7. The method of claim 1, wherein:
the first code word has a fixed length.

8. The method of claim 1, wherein:
the data comprise ring tone data.

9. The method of claim 8, wherein:
the telephone is adapted to play back the ring tone data in response to the recovered characteristics.

10. The method of claim 8, wherein:
one of the respective characteristics comprises a note.

11. The method of claim 8, wherein:
one of the respective characteristics comprises a note length.

12. The method of claim 8, wherein:
one of the respective characteristics comprises an octave.

13. The method of claim 8, wherein:
one of the respective characteristics comprises a volume.

14. An apparatus for encoding data for use by a telephone, comprising:
an encoder for providing the data in at least a first code word having a plurality of respective code portions;
wherein each respective code portion comprises at least one bit and is correlated by its relative position within the first code word with a respective characteristic of the data.

15. An apparatus for encoding data for use by a telephone, comprising:
means for providing the data in at least a first code word having a plurality of respective code portions;
wherein each respective code portion comprises at least one bit and is correlated by its relative position within the first code word with a respective characteristic of the data.

16. A method for encoding data for use by a telephone, comprising:
providing baseline data in at least a first code word having a plurality of respective code portions; and
providing at least a second code word that follows the first code word and contains instruction data for modifying a playback at the telephone of the baseline data;
wherein at least one of the respective code portions of the first code word designates that the second code word follows the first code word and contains the instruction data.

17. The method of claim 16, wherein:
the respective code portions have respective predetermined lengths.

18. The method of claim 16, wherein:
the telephone comprises an over-the-air telephone.

19. The method of claim 16, wherein:
at least one code portion of the second code word designates that at least a third code word follows the second code word and contains additional instruction data for modifying the playback of the baseline data.

20. The method of claim 16, wherein:
the telephone is adapted to recover the baseline data from the first code word, and the instruction data from the second code word, and to playback the baseline data in a modified manner in accordance with the instruction data.

21. The method of claim 16, wherein:
the baseline data comprises baseline ring tone data.

22. The method of claim 21, wherein:
the instruction data comprises a tempo change instruction.

23. The method of claim 21, wherein:
the instruction data comprises a sound looping instruction.

24. The method of claim 21, wherein:
at least one code portion of the second code word designates that at least a third code word follows the second code word and contains additional instruction data for modifying the playback of the baseline ring tone data.

25. The method of claim 21, wherein:
the telephone is adapted to recover the baseline ring tone data from the first code word, and the instruction data from the second code word, and to playback the baseline ring tone data in a modified manner in accordance with the instruction data.

26. An apparatus for encoding data for use by a telephone, comprising:
an encoder for providing baseline data in at least a first code word having a plurality of respective code portions, and for providing at least a second code word that follows the first code word and contains instruction data for modifying a playback at a telephone of the baseline data;
wherein at least one of the respective code portions of the first code word designates that the second code word follows the first code word and contains the instruction data.

27. The apparatus of claim 26, wherein:
the respective code portions have respective predetermined lengths.

28. A method for decoding data at a telephone, comprising:
receiving the data at the telephone in at least a first code word having a plurality of respective code portions, each comprising at least one bit; and
correlating each respective code portion by its relative position within the first code word with a respective characteristic of the data.

29. The method of claim 28, wherein:
the respective code portions have respective predetermined lengths.

30. The method of claim 28, wherein the data is communicated to the telephone via a network, further comprising:
recovering the respective characteristics of the data from the first code word according to the correlated position of each code portion therein.

31. The method of claim 30, further comprising:
playing back the data in response to the recovered characteristics.

32. The method of claim 28, wherein:
the telephone comprises an over-the-air telephone.

33. The method of claim 28, wherein:
the first code word comprises an integral number of bytes.

34. The method of claim 28, wherein:
the first code word has a fixed length.

35. The method of claim 28, wherein:
the data comprise ring tone data.

36. The method of claim 35, further comprising:
playing back the ring tone data in response to the recovered characteristics.

37. The method of claim 35, wherein:
one of the respective characteristics comprises a note.

38. The method of claim 35, wherein:
one of the respective characteristics comprises a note length.

39. The method of claim 35, wherein:
one of the respective characteristics comprises an octave.

40. The method of claim 35, wherein:
one of the respective characteristics comprises a volume.

41. An apparatus for decoding data at a telephone, comprising:
a receiver for receiving the data in at least a first code word having a plurality of respective code portions, each comprising at least one bit; and
a decoder for correlating each respective code portion by its relative position within the first code word with a respective characteristic of the data.

42. An apparatus for decoding data at a telephone, comprising:
means for receiving the data in at least a first code word having a plurality of respective code portions, each comprising at least one bit; and
means for correlating each respective code portion by its relative position within the first code word with a respective characteristic of the data.

43. A method for decoding data at a telephone, comprising:
receiving baseline data in at least a first code word having a plurality of respective code portions, and at least a second code word that follows the first code word and contains instruction data for modifying a playback at a telephone of the baseline data;
wherein at least one of the respective code portions of the first code word designates that the second code word follows the first code word and contains the instruction data.

44. The method of claim 43, wherein:
the respective code portions have respective predetermined lengths.

45. The method of claim 43, wherein:
the telephone comprises an over-the-air telephone.

46. The method of claim 43, wherein:
at least one code portion of the second code word designates that at least a third code word follows the second code word and contains additional instruction data for modifying the playback of the baseline data.

47. The method of claim 43, wherein the baseline data and the instruction data are communicated to the telephone via a network, further comprising:
recovering the baseline data from the first code word, and the instruction data from the second code word; and
playing back the baseline data in a modified manner in accordance with the instruction data.

48. The method of claim 43, wherein:
the baseline data comprises baseline ring tone data.

49. The method of claim 48, wherein:
the instruction data comprises a tempo change instruction.

50. The method of claim 48, wherein:
the instruction data comprises a sound looping instruction.

51. The method of claim 48, wherein:
at least one code portion of the second code word designates that at least a third code word follows the second code word and contains additional instruction data for modifying the playback of the baseline ring tone data.

52. The method of claim 48, wherein the baseline ring tone data and the instruction data are communicated to the telephone via a network, further comprising:
recovering the baseline ring tone data from the first code word, and the instruction data from the second code word; and
playing back the baseline ring tone data in a modified manner in accordance with the instruction data.

53. An apparatus for decoding data for use by a telephone, comprising:
a decoder for receiving baseline data in at least a first code word having a plurality of respective code portions, and at least a second code word that follows the first code word and contains instruction data for modifying a playback at a telephone of the baseline data;
wherein at least one of the respective code portions of the first code word designates that the second code word follows the first code word and contains the instruction data.

54. The apparatus of claim 53, wherein:
the respective code portions have respective predetermined lengths.

55. A method for encoding bitmap image data for use by a telephone, comprising:
providing a first code portion designating a bitmap type, a second code portion designating a bitmap width, a third code portion designating a bitmap height, and a fourth code portion designating the bitmap image data.

56. The method of claim 55, wherein:
the bitmap image data comprises at least one of a caller group icon and an operator logo.

57. A method for encoding access point data for use by a telephone, comprising:
providing a first code portion that designates a logical proxy, a second code portion that designates a physical proxy, a third code portion that designates a port of the physical proxy that the telephone connects to, and a fourth code portion that designates a network access point.
